(19) United States
(12) Patent Application Publication
(10) Pub. No.: US 2012/0085429 A1
(43) Pub. Date: Apr. 12, 2012

(54) AIR PRESSURE ADJUSTABLE ELASTIC BODY

(76) Inventor: Teng-Jen YANG, Wufeng Shiang (TW)

(21) Appl. No.: 12/901,351

(22) Filed: Oct. 8, 2010

(51) Int. Cl. F16K 15/20

(52) U.S. Cl. 137/223

(57) ABSTRACT

An air pressure adjustable elastic body is integrally formed with an inflation/deflation module on a joining member which is formed by plastic injection molding. With the inflation/deflation module, the user can adjust the air pressure in the elastic body as desired, improving the application of the elastic body. Furthermore, since all components of the elastic body are formed by the plastic injection molding, the manufacturing procedure can be simplified, reducing the production cost while enhancing the economic benefit. In addition, since the elastic body is formed by the integral injection molding, it has no structural defects.

### BACKGROUND OF THE INVENTION

1. Field of the Invention

The present invention relates to an elastic buffer member, and more particularly to an air pressure adjustable elastic body.

2. Description of the Prior Art

Referring to FIG. 1, a conventional elastic body 10 comprises two joining members 11 that are oppositely connected. The two joining members 11 are formed by plastic injection molding. A connecting member 12 connects the two joining members 11 of elastic body 10 by injection welding.

While the connecting member 20 is made by injection molding, the gas produced by the injection molding of the connecting member 20 can be charged into the elastic body to make the elastic body have a buffer elasticity to offer a buffer function. The joining members 11 are also made by injection molding, so that the shape and the thickness of the joining members can be controlled by changing the mold, thus not only making the production convenient but improving the product yield and widening the application range. However, the buffer ability of the above elastic body is fixed after the formation and cannot be adjusted as desired.

The present invention has arisen to mitigate and/or obviate the afore-described disadvantages.

### SUMMARY OF THE INVENTION

The primary objective of the present invention is to provide an air pressure adjustable elastic body which can be applied in different conditions since the air pressure can be adjusted by the user.

To achieve the above objective, an air pressure adjustable elastic body in accordance with the present invention comprises two joining members and a connecting member.

The two joining members are oppositely connected. Each of the joining members includes an inner surface and an outer surface and is formed with a connecting edge along a circumference thereof. The connecting edge extends outwards from the respective joining members. A first joining member of the two joining members is formed with an accommodation space. The two joining members are disposed in such a manner that the two inner surfaces of the two joining members are oppositely arranged while the two connecting edges abut against each other. The respective joining members are formed by plastic injection molding, and a second joining member of the two joining members is provided with at least one inflation/deflation module.

The inflation/deflation module includes an inflation apparatus passage unit and a restoration unit that are integrally formed by injection molding. The inflation apparatus passage unit is a hollow structure protruding from the inner surface of the second joining member and includes an inflation apparatus insertion space which is open toward the outer surface of the second joining member. The inflation apparatus passage unit is formed with a notch, and an extending direction of the notch is defined as a notch direction. The notch is in communication with the inflation apparatus insertion space.

The restoration unit is integrally formed with the inflation apparatus passage unit by plastic injection molding. The restoration unit produces an elastic restoration force in an elastic restoration force direction which is vertical to the notch direction and applies the elastic restoration force to the notch from two opposite sides of the notch.

The connecting member connects the two joining member by injection welding and is formed by injection molding while sealing gas between the two joining members.

With the inflation/deflation module, the user can inflate or deflate the elastic body to adjust the air pressure of the elastic body. The restoration unit can force the notch to closely abut against the inflation head to avoid the occurrence of clearance between the inflation head and the notch, ensuring the airtightness. Furthermore, the elastic body of the present invention is formed by the integral injection molding, such that the manufacturing procedure is simplified, reducing the production cost while enhancing the economic benefit.

### BRIEF DESCRIPTION OF THE DRAWINGS

FIG. 1 is an exploded view of a conventional elastic body;

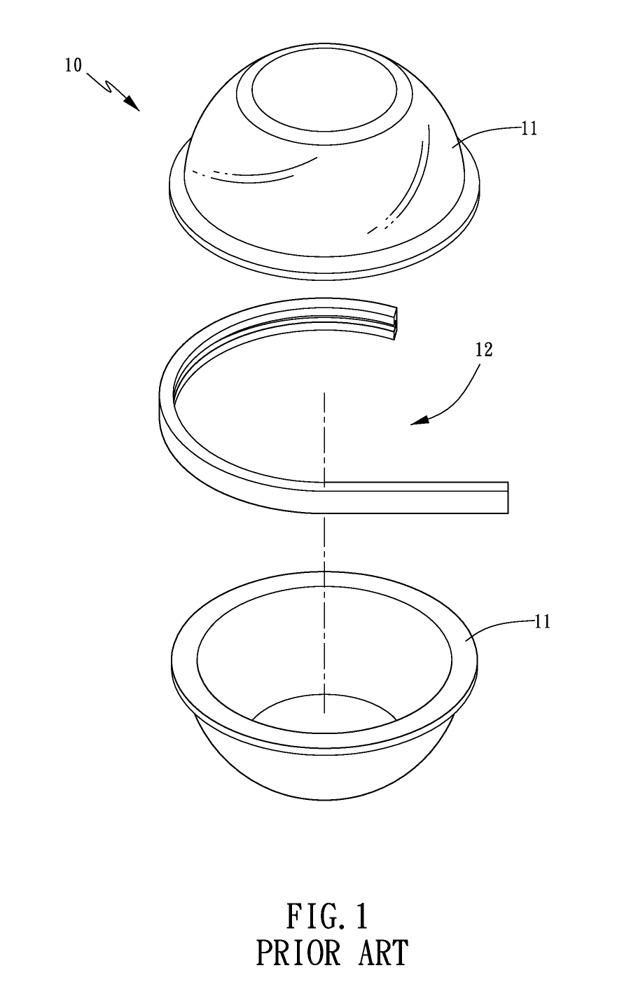

FIG. 2 is an exploded view of an air pressure adjustable elastic body in accordance with the present invention;

FIG. 3 is an assembly view of the air pressure adjustable elastic body in accordance with the present invention;

FIG. 4 is a cross-sectional view of the air pressure adjustable elastic body in accordance with the present invention;

FIG. 5 is an operational view showing that the air pressure adjustable elastic body in accordance with the present invention cooperates with an inflation head; and

FIG. 6 is another operational view showing that the air pressure adjustable elastic body in accordance with the present invention cooperates with an inflation head.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

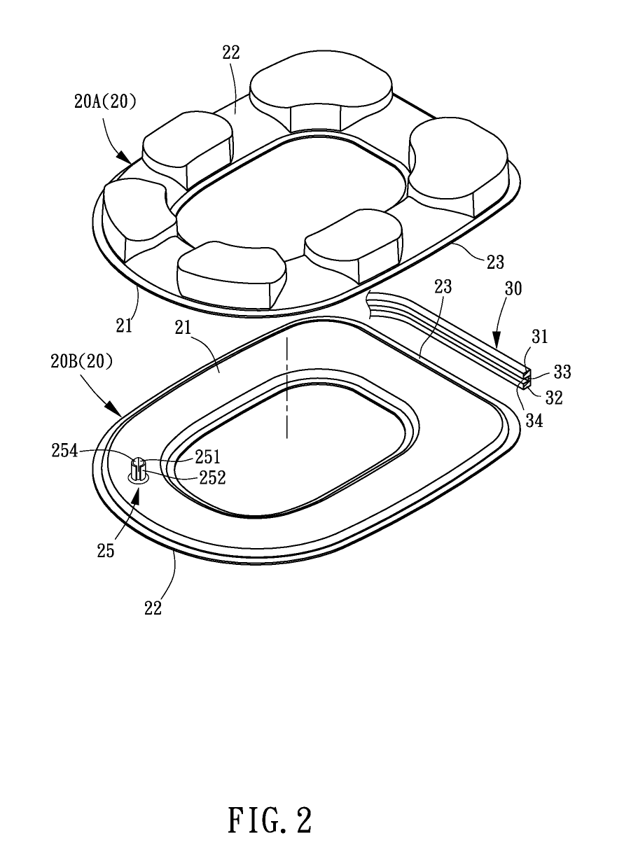

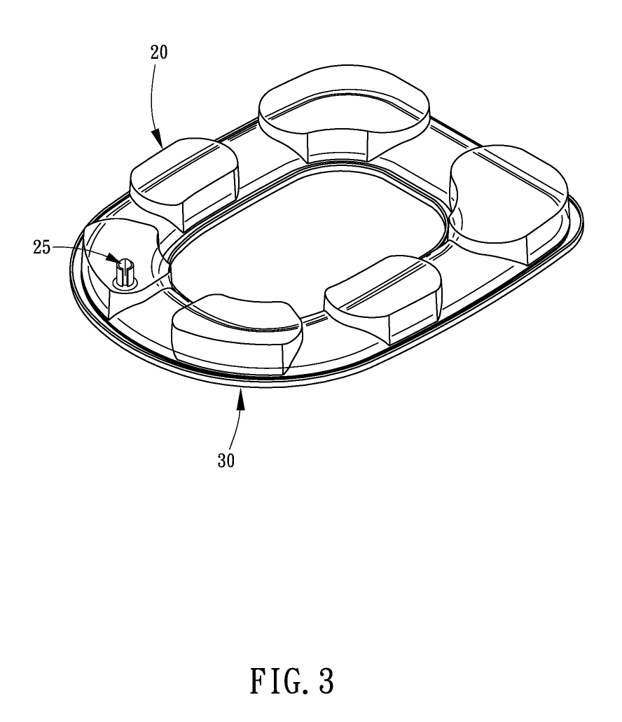

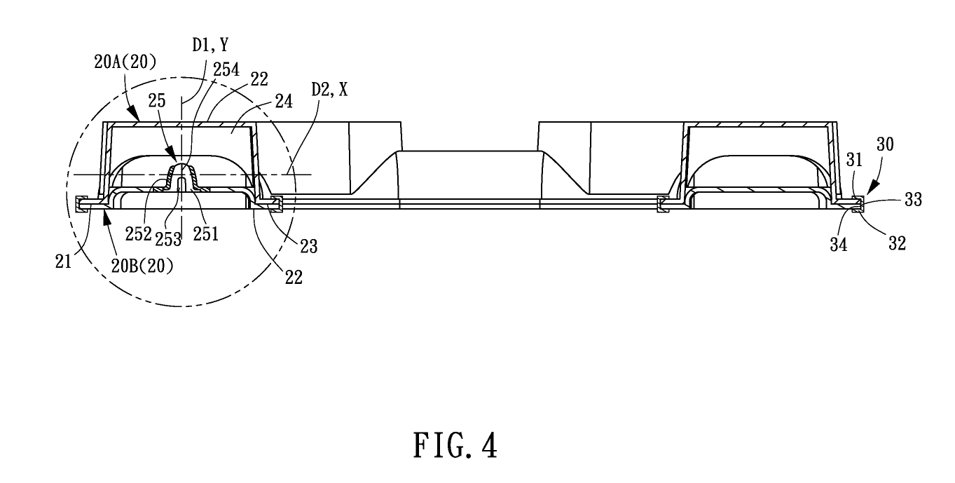

Referring to FIGS. 2-5, an air-pressure adjustable elastic body in accordance with the present invention comprises plural joining members 20 and a connecting member 30.

In the present embodiment, the air-pressure adjustable elastic body comprises two joining members 20A, 20B that are oppositely connected. The two joining members 20A, 20B are the same in circumference shape. The joining member 20A is an empty shell while the joining member 20B is a plane structure. The respective joining members 20A, 20B are formed by plastic injection molding. Each of the joining members 20A, 20B includes an inner surface 21 and an outer surface 22. At a joint of the inner surface 21 and the outer surface 22 of the respective joining members 20A, 20B is formed a connecting edge 23 along the circumference of the respective joining members 20A, 20B, and the connecting edges 23 extend outwards from the respective joining members 20A, 20B. An extending direction of the connecting edge 23 is defined as a horizontal direction X. A direction vertical to the horizontal direction X is defined a longitudinal direction Y. The joining member 20A is formed with an accommodation space 24 in the longitudinal direction Y. The two joining members 20A, 20B are disposed in such a manner that the two inner surfaces 21 of the two joining members 20A, 20B are oppositely arranged while the two connecting edges 23 abut against each other. The joining member 20B is provided on the inner surface 21 thereof with at least one inflation/deflation module 25.

The inflation/deflation module 25 includes an inflation apparatus passage unit 251 and a restoration unit 252 that are integrally formed.

The inflation apparatus passage unit 251 is a hollow structure protruding from the inner surface 21 of the joining member 20B and includes an inflation apparatus insertion space 253 which is open toward the outer surface 22 of the joining member 20B. The inflation apparatus passage unit 251 is further formed with a notch 254 in an end thereof which protrudes toward the inner surface 21 of the joining member 20A. An extending direction of the notch 254 is defined as a notch direction D1, and the notch direction D1 is parallel to the longitudinal direction Y. The notch 254 is in communication with the inflation apparatus insertion space 253.

The restoration unit 252 is integrally formed with the inflation apparatus passage unit 251 by plastic injection molding. The restoration unit 252 produces an elastic restoration force F in an elastic restoration force direction D2 which is vertical to the notch direction D1 but parallel to the horizontal direction X. The restoration unit 252 applies the elastic restoration force F to the notch 254 from two opposite sides of the notch 254. In the present embodiment, the restoration unit 252 encloses an outer periphery of the inflation apparatus passage unit 251 fully. In addition, the restoration unit 252 can also partially enclose the inflation apparatus passage unit 251 with the notch 254 exposed. The joining members 20A, 20B, the inflation apparatus passage unit 251 and the restoration unit 252 are all formed by the plastic injection molding. The elastic restoration ability of the inflation apparatus passage unit 251 is greater than that of the restoration unit 252, and the inflation apparatus passage unit 251 and the restoration unit 252 are made of different characteristics of plastic materials.

The connecting member 30 is an integral structure formed by the plastic injection molding and includes an upper portion 31, a lower portion 32 and a lateral portion 33 which connects the upper portion 31 and the lower portion 32. The upper portion 31 and the lower portion 32 cooperate with the lateral portion 33 to define a clamping opening 34 for enclosing the connecting edges 23 of the two joining members 20A, 20B and sealing the two joining members 20A, 20B. The gas produced by heating the plastic will be charged between the two joining members 20A, 20B during the plastic injection molding of the connecting member 30.

The aforementioned is the summary of the positional and structural relationship of the respective components of the preferred embodiment in accordance with the present invention.

The respective joining members 20A, 20B are integrally formed by the plastic injection molding, and the inflation/deflation module 25 is also integrally formed on the joining member 20B by the plastic injection molding, so that the respective joining members 20A, 20B are elements that are suitable for quick mass production. After the respective joining members 20A, 20B are formed and joined together, the connecting member 30 will be formed by the plastic injection molding to seal the respective joining members 20A, 20B, and the gas produced during the plastic injection molding of the connecting member 30 will be sealed in the accommodation space 24 between the joining members 20A, 20B. By such arrangements, with the gas between the joining members 20A, 20B, the elastic body of the present invention can offer the buffer elasticity.

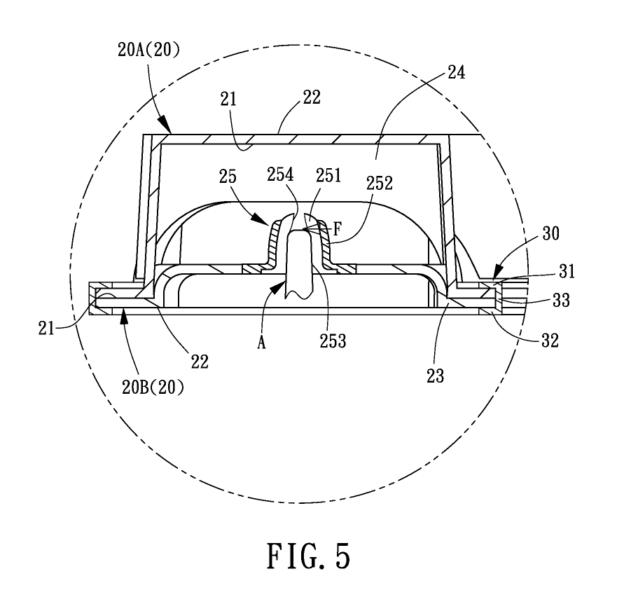

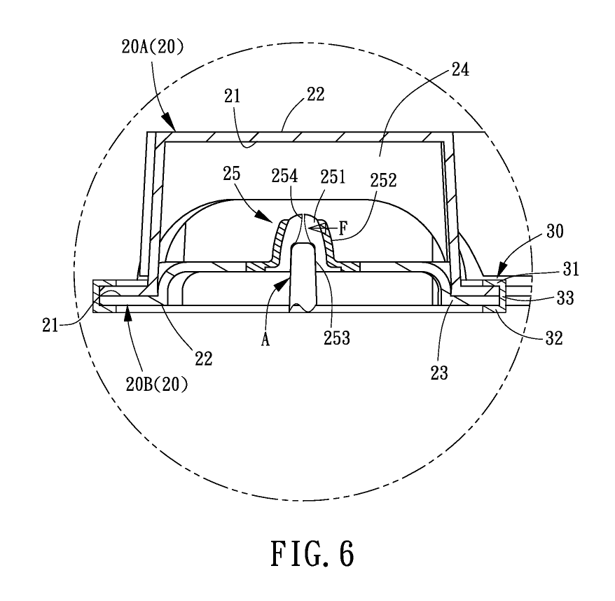

When the elastic body of the present invention is used in different conditions or by different users, the buffer elasticity can be adjusted as desired through the inflation/deflation module 25. As shown in FIGS. 5-6, the user can insert an inflation head A of an inflation apparatus into the space defined between the two joining members 20A, 20B through the notch 254 of the inflation apparatus passage unit 251 from the inflation apparatus insertion space 253 to inflate the elastic body of the present invention. At this moment, the inflation head A props the notch 254 of the inflation apparatus passage unit 251 open. As a result of this, the inflation apparatus passage unit 251 will apply a force onto the restoration unit 252 to make it expand outwards. Since the elastic restoration force F of the restoration unit 252 is applied on the notch 254 from the two opposite sides of the notches 254, although the inflation head A props the notch 254 open during the inflation process, the restoration unit 252 will force the notch 254 to closely abut against the inflation head A without causing clearance between the inflation head A and the notch 254, avoiding the gas leakage.

After finishing the inflation, the user will draw the inflation head A out. When the inflation head A disengages from the notch 254, the inflation head A will apply the elastic restoration force F onto the notch 254 continuously to close the notch 254 quickly. As shown in FIG. 5, after the inflation head A completely disengages from the notch 254, the restoration unit 252 will make the notch 254 to restore to its original closed state, preventing the gas from leaking through the notch 254. In addition, the gas in the elastic body can further produce inner pressure to enhance the closing force.

Furthermore, when the user needs to deflate the elastic body of the present invention, he can prop the notch 254 of the inflation/deflation module 25 open, and then the gas will be discharged through the notch 254, realizing the objective of deflation. When the user stops propping the notch 254 open, the elastic restoration force F of the restoration unit 252 will make the notch 254 restore to its original closed state.

Since the elastic body of the present invention is integrally formed by the plastic injection molding, the present invention has no structural defects. In addition, there is no open clearance between the joining members, the inflation apparatus passage unit 251 and the restoration unit 252, ensuring a high airtightness of the elastic body of the present invention. With the inflation/deflation module 25, the user can change the air pressure of the elastic body of the present invention to adjust the buffer elasticity of the elastic body of the present invention, improving the application of the elastic body of the present invention while enhancing the added value of the elastic body of the present invention.

While we have shown and described various embodiments in accordance with the present invention, it is clear to those skilled in the art that further embodiments may be made without departing from the scope of the present invention.

What is claimed is:

1. An air-pressure adjustable elastic body comprising:
two joining members oppositely connected, each of the joining members including an inner surface and an outer surface and being formed with a connecting edge along a circumference thereof, the connecting edge extending outwards from the respective joining members, a first joining member of the two joining members being formed with an accommodation space, the two joining members being disposed in such a manner that the two inner surfaces of the two joining members are oppositely arranged while the two connecting edges abut against each other, the respective joining members being formed by plastic injection molding, a second joining member of the two joining members being provided with an inflation/deflation module which inflates/deflates the elastic body; and
a connecting member connecting the two joining member by injection welding, the connecting member being formed by injection molding while sealing gas between the two joining members.

2. The air-pressure adjustable elastic body as claimed in claim 1, wherein the inflation/deflation module is disposed on the inner surface of the second joining member and includes an inflation apparatus passage unit and a restoration unit that are integrally formed by injection molding, the inflation apparatus passage unit is a hollow structure protruding from the inner surface of the second joining member and includes an inflation apparatus insertion space which is open toward the outer surface of the second joining member, the inflation apparatus passage unit is formed with a notch, an extending direction of the notch is defined as a notch direction, the notch is in communication with the inflation apparatus insertion space, the restoration unit is integrally formed with the inflation apparatus passage unit by plastic injection molding, the restoration unit produces an elastic restoration force in an elastic restoration force direction which is vertical to the notch direction, the restoration unit applies the elastic restoration force to the notch from two opposite sides of the notch.

3. The air-pressure adjustable elastic body as claimed in claim 1, wherein the joining members are the same in circumference shape.

4. The air-pressure adjustable elastic body as claimed in claim 1, wherein the first joining member is an empty shell, and the second joining member is a plane structure.

5. The air-pressure adjustable elastic body as claimed in claim 1, wherein the connecting edge is formed at a joint of the inner surface and the outer surface of the respective joining members along the circumference of the respective joining members.

6. The air-pressure adjustable elastic body as claimed in claim 5, wherein an extending direction of the connecting edge of the respective joining members is defined as a horizontal direction, a direction vertical to the horizontal direction is defined as a longitudinal direction, the first joining member is formed the accommodation space along the longitudinal direction.

7. The air-pressure adjustable elastic body as claimed in claim 1, wherein the connecting member is an integral structure and includes an upper portion, a lower portion and a lateral portion which connects the upper portion and the lower portion, the upper portion and the lower portion cooperate with the lateral portion to define a clamping opening for enclosing the connecting edges of the two joining members and sealing the two joining members.

8. The air-pressure adjustable elastic body as claimed in claim 2, wherein the inflation apparatus passage unit is formed with the notch in an end thereof which protrudes toward the inner surface of the first joining member.

9. The air-pressure adjustable elastic body as claimed in claim 2, wherein the restoration unit encloses an outer periphery of the inflation apparatus passage unit fully.

10. The air-pressure adjustable elastic body as claimed in claim 2, wherein the restoration unit partially encloses an outer periphery of the inflation apparatus passage unit with the notch exposed.

11. The air-pressure adjustable elastic body as claimed in claim 2, wherein an elastic restoration ability of the restoration unit is greater than that of the inflation apparatus passage unit.

12. The air-pressure adjustable elastic body as claimed in claim 2, wherein the restoration unit and the inflation apparatus passage unit are made of different characteristics of plastic materials.
